(19) United States
(12) Patent Application Publication
(10) Pub. No.: US 2007/0043453 A1
(43) Pub. Date: Feb. 22, 2007

(54) Tunneled receiver for point and act remote control

(75) Inventor: Vincentius P. Buil, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/574,139

(22) PCT Filed: Sep. 27, 2004
(86) PCT No.: PCT/IB04/51884

§ 371 Date: Mar. 29, 2006

Related U.S. Application Data
(60) Provisional application No. 60/507,284, filed on Sep. 30, 2003.

(51) Int. Cl. G05B 19/18

(52) U.S. Cl. 700/65; 700/66

(57) ABSTRACT

A remote control that broadcasts signals over a broader directional path than it receives signals from. In operation, the remote control first is directed towards a particular device. In response to user input, the remote control device broadcasts a wakeup signal that solicits transmission of identifying signals from each device within a broadcast area The remote control device then awaits receipt of the identifying signal for the particular device. Since the remote control only receives signals over a relatively narrow directional path, the remote ontrol only will receiv tthe identification signal from the particular device that it is directed towards even though there may be more than one device in the broadcast area. After the identification signal of the particular device is received, the remote control may then transmit a control signal to the particular device. The control signal is at least partially determined from the received identifying signal.

The present invention generally relates to a method and device for controlling other devices that have controllable characteristics and particularly relates to a method and remote control device for selectively controlling one of a plurality of devices.

Conventional remote control devices are known that can control one or more controllable devices. For instance, televisions oftentimes have a remote control for controlling the controllable characteristics including, channel, volume, menu functions, etc. Videocassette recorders also may have a remote control for controlling similar functions and others including recording times, recording channel, etc. Even fans, lights, air conditioners, etc. may have remote controls but the problem is that with all of these remotely controllable devices, there becomes an overwhelming abundance of remote controls that are needed within a household. Whenever a user wishes to control a particular device, the remote control for that device must be located and operated.

Manufacturers of these controllable devices have long recognized that it may be desirable to have a single remote that can control a plurality of devices. Remote controls that can control a plurality of devices accomplish this task in numerous ways. One type of known remote control has permanently stored control information for a plurality of controllable devices. A user wishing to use this device, must first look up in a table of identifying codes the identifying code for each of the devices that the user wishes to control. These codes are provided to the remote control during an initial setup period and are stored. Thereafter, when the user wishes to control a particular controllable device, a device selection must first be made on the remote control. This device selection typically may be the sliding of a selector switch or the depression of a key that identifies a given device, such as pressing a key labeled TV for using the remote control to control a television. Only after the desired controllable device is identified to the remote control, may the user control the desired controllable device. Another type of remote control device requires a learning period to learn specific commands of the controllable device. In either event, prior to using the remote control to control a controllable device, the user must first manually select the controllable device that a user wishes to control.

This identification of a controllable device to the remote control prior to being enabled to control the controllable device is an awkward step for the user. In some instances, there may be more-than one of a given type of controllable device in a given space. Yet to enable the user to control a particular one of the controllable devices, each must be uniquely identified and separately selectable by a selection input on the remote control. This at best leads to further confusion of the user and may not even be possible in prior known remote controls.

U.S. Pat. No. 5,554,979 (the '979 Patent) assigned to the same assignee as the present patent application uses an alternate method of controlling a controllable device characteristic. The '979 patent is incorporated herein by reference hereto as if set out in its entirety. The '979 Patent utilizes a remote control device that transmits control signals over a narrow directional path such that control of a particular controllable device is accomplished by pointing the remote control device in the direction of the particular controllable device. To effect multiple control functions, multiple receivers are described for each controllable device wherein each of the receivers is configured to receive a control signal and thereby effect a different control. This system is very cumbersome in that multiple receivers are required for each controllable device. Also, since the control signals transmitted by the remote control device do not contain any identification information identifying the particular controllable device, the remote control device must continue to be pointed in the direction of a controllable device to effect control. In the event that the remote control device is improperly aligned with a desired controllable device during a control operation, then the desired controllable device will not be controlled. Further, any errantly received signal by another controllable device may improperly initiate a control function of the improper controllable device.

Accordingly, it is an object of the present invention to overcome one or more of the disadvantages of the prior art.

A system and method of controlling a controllable device is disclosed. A remote control of the system includes a transceiver and a user input. The controllable devices of the system also have transceivers and are positionally displaced from each other. The transceiver of the remote control broadcasts signals over a broader directional path than it receives signals from.

In operation, the remote control is directed towards a particular controllable device. In response to user input, the transceiver of the remote control device broadcasts a wakeup signal that solicits transmission of identifying signals from controllable devices within a broadcast area. Each of the controllable devices within the broadcast area transmits corresponding identification information in response to the wakeup signal. The remote control device then awaits receipt of the identifying signal for the particular controllable device. The remote control only receives identification signals from the particular controllable device that it is directed towards since the remote control only receives signals over a relatively narrow directional path. This is true even though there may be more than one controllable device in the area.

After the identification signal of the particular controllable device is received, the remote control may then transmit a control signal to the particular controllable device to adjust a characteristic of the particular controllable device. The control signal is at least partially determined from the received identifying signal. In this way, only the particular controllable device that is identified is controlled, even in an event wherein the remote control device is not aligned with the particular controllable device when a control signal is initiated.

These and other features and advantages of the present invention will become more apparent from the accompanying drawings and the following description.

The following are descriptions of illustrative embodiments of the present invention that when taken in conjunction with the following drawings will demonstrate the above noted features and advantages, as well as further ones. It should be expressly understood that the drawings are included for illustrative purposes and do not represent the scope of the present invention. In the figures, like parts of the system are denoted with like numbers.

The invention is best understood in conjunction with the accompanying drawings in which:

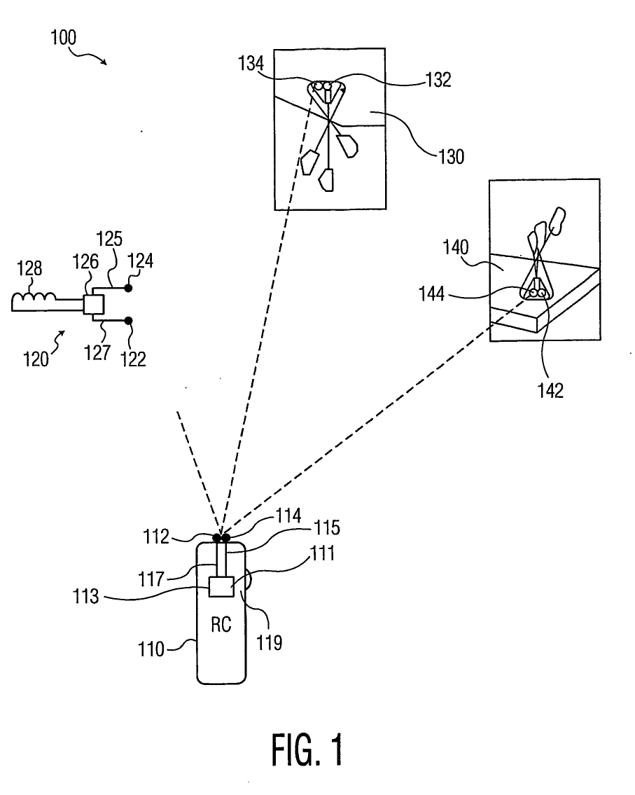

FIG. 1 shows an illustrative system in accordance with an embodiment of the present invention;

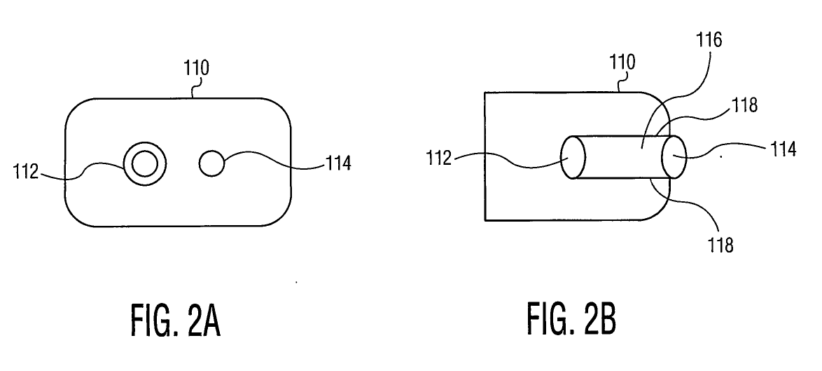

FIG. 2A shows an embodiment of a front view of a remote control device in accordance with the present invention;

FIG. 2B shows an embodiment of a side view of a remote control device in accordance with the present invention;

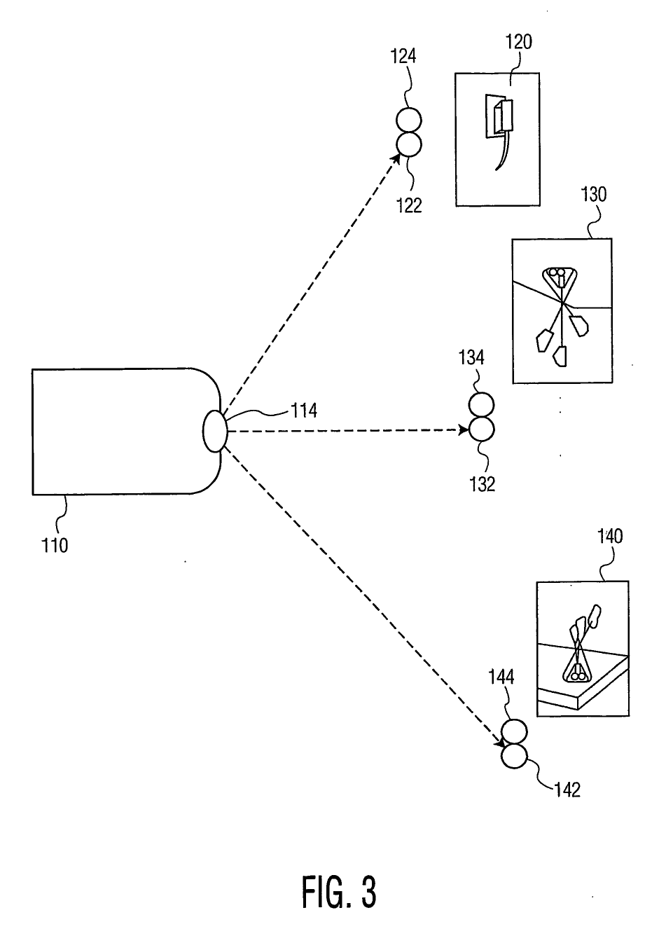

FIG. 3 shows an illustrative system including a side view of a remote control device and controllable devices in accordance with an embodiment of the present invention;

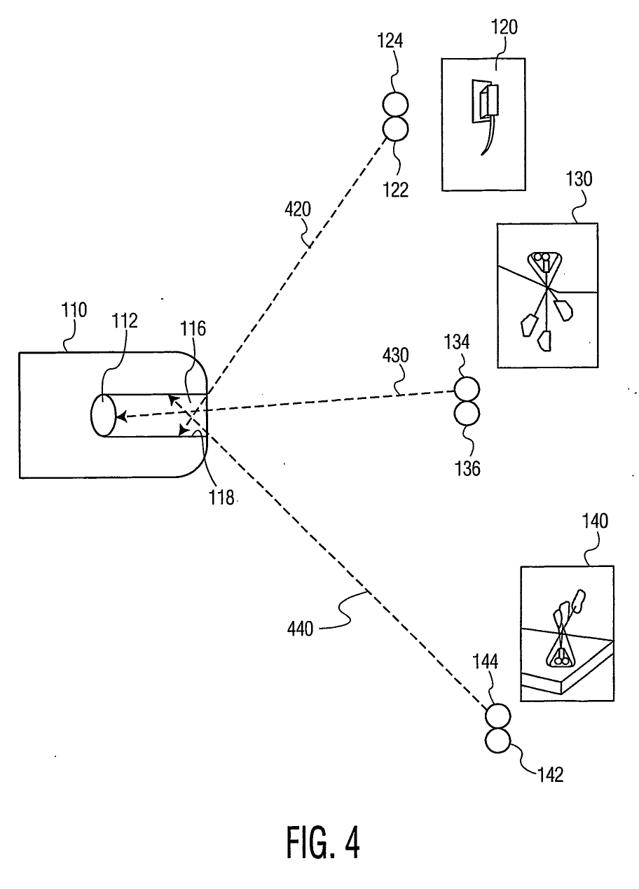

FIG. 4 shows an illustrative operation of a system including a side view of a remote control device and controllable devices in accordance with an embodiment of the present invention;

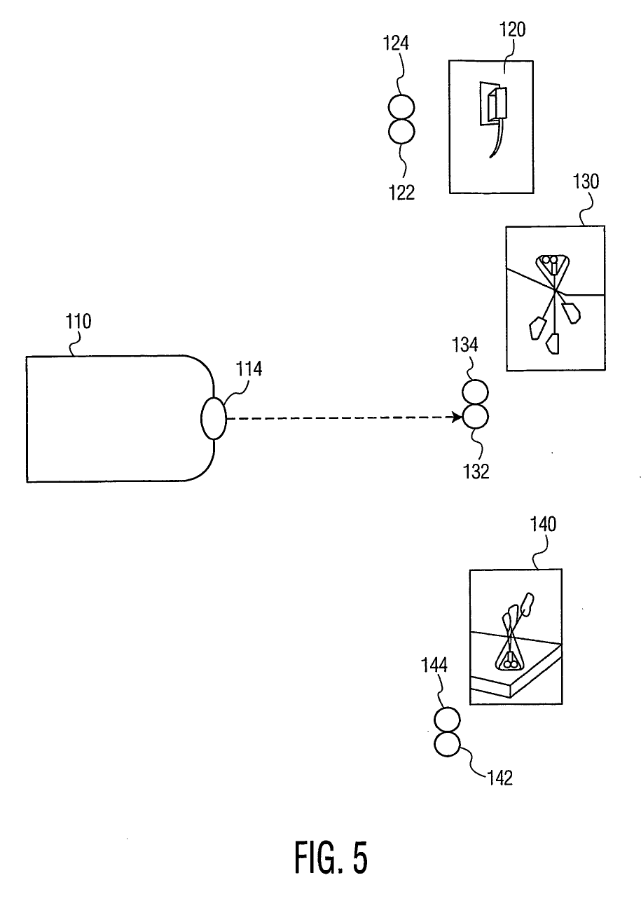

FIG. 5 shows an illustrative operation of a system including a side view of a remote control device and controllable devices in accordance with an embodiment of the present invention;

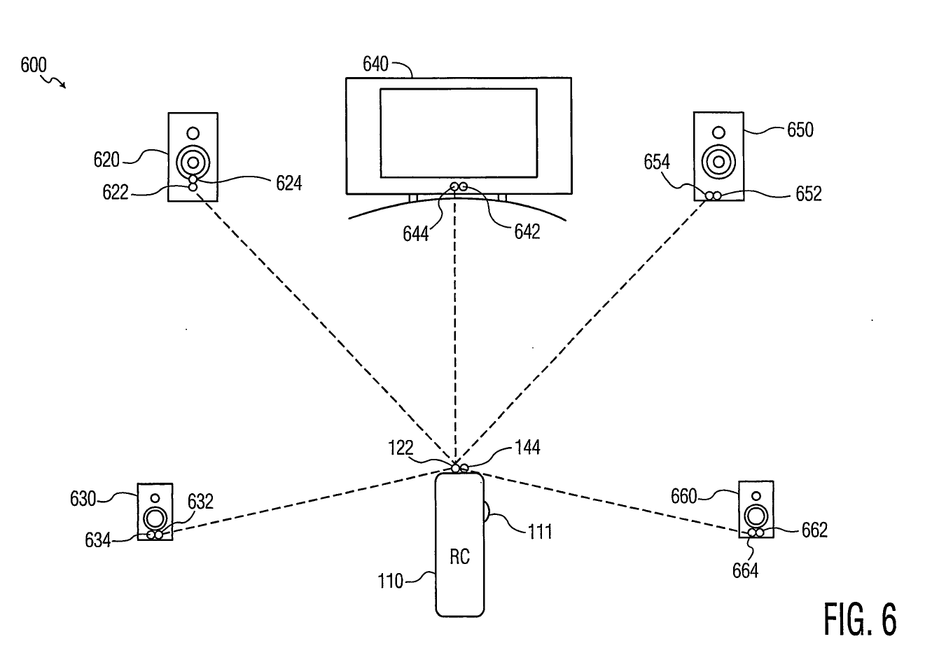

FIG. 6 shows an illustrative alternate embodiment of a system including a side view of a remote control device and controllable devices in accordance with an embodiment of the present invention; and

FIG. 7 shows a flow diagram illustrating operation of a system in accordance with an embodiment of the present invention.

FIG. 1 shows an illustrative embodiment of a system 100 in accordance with an embodiment of the present invention including a remote control device 110, and controllable devices 120, 130, 140. In accordance with the present invention, controllable devices 120, 130, 140 each respectively have receiving devices 122, 132, 142 and sending devices 124, 134, 144 operationally coupled to the respective controllable devices 120, 130, 140. The receiving devices 122, 132, 142 may be understood to be receivers, as is known in the art. The receiving devices receive given signals for respective controllable devices 120, 130, 140. Further, the sending devices 124, 134, 144 may be understood to be transmitters as is known in the art. The sending devices transmit given signals that are particular to respective controllable devices 120, 130, 140.

In accordance with the present invention, controllable devices include operationally coupled respective receiving and sending devices. The term operationally coupled and coupled is intended to mean that the controllable devices may receive control signals, such as a wake-up signal, an adjustment signal, etc., by way of respective receiving devices. In receiving the control signal, the controllable devices react in accordance with the type of control signal received. The sending devices of respective controllable devices send at least an identification signal when appropriate as discussed in more detail below.

Similarly, receiving and sending devices of remote control devices are operationally coupled within the remote control device. The remote control device may receive identifying signals from controllable devices by way of respective receiving devices. The sending devices of a respective remote control send at least a wakeup signal and control signals when appropriate.

As would be readily apparent to a person of ordinary skill in the art, the particular coupling within a remote control and controllable devices is not necessarily intended to limit the present invention unless specifically recited as a limitation of a claim. Many types of couplings would be readily apparent to a person of ordinary skill in the art. For example, the coupling may be a physical coupling, such as electrical wiring, a fiber optical coupling, etc. The coupling may also be a wireless coupling, or any other coupling that enables communication within the remote control device and within the controllable device so long as each device is enabled to operate in accordance with the description contained herein.

In fact, the couplings within a controllable/remote control device and respective receiving and sending devices may vary amongst devices, such as the receiving device being wirelessly coupled within the controllable device while the sending device is coupled via an electrical wire. Further the coupling within a given controllable/remote control device of a system may be different than another given controllable/remote control device of the system. In this or another embodiment, the receiving and sending devices may alternatively be integrated directly with the controllable/remote control device.

FIG. 1 shows a further detail of an illustrative controllable device, in this instance controllable device 120. The controllable device 120 illustratively includes a control portion 126 coupled to the receiving and sending devices 122, 124 via respective couplings 127, 125. The control portion 126 is further shown coupled to a controlled element 128, such as a lighting element. The control portion 126 may illustratively be a processor-based circuit having either or both of a hardware and software portion for operation in accordance with the present invention. The control portion 126 is configured (e.g., programmed) to receive signals via coupling 127 that are received by the receiving device 122. The control portion 126 is also configured to control the controlled element 128 in response to signals received from the receiving device 122. Further, the control portion 126 is configured to cause the sending device 124 to transmit signals when operating in accordance with the present invention.

As would also be apparent, while the controllable device 120, for example, is illustratively shown as a lamp. It should be clear that any device having adjustable characteristics that may be remotely controlled, including audio equipment, video equipment, climate control equipment, curtains, garage doors, kitchen equipment, laundry machines, machines/robots for example in a production line, medical equipment, stadium lighting & sound, street lights, video projectors, toys, CE products in a shop, and of course many others may be operated within the scope of the present invention.

As an example, for a lighting controllable device, the control signal may cause a lighting element to go on, off, adjust brightness, etc. For audio/visual controllable device, the control signal may cause a tuning element to tune to an alternate signal source, may cause a volume control device to increase or decrease a volume, may cause the audio/visual controllable device to turn on/off, etc. In fact as should be clear, any characteristic of a given controllable device may be controlled in accordance with the present invention. Accordingly, any of these types of devices and others should be understood to be within the scope of the present invention.

As further shown in FIG. 1, the remote control device 110 is schematically shown as including a control portion 113 operatively coupled to a receiving device 112 and a sending device 114 via respective couplings 117, 115. The control portion is further coupled via coupling 119 to a user input device 111 for enabling user activation, selection, and control. Illustratively, the user input device 111 may be a simple push-button input, dial (e.g., rotatable) input, slider input, joystick, etc. The remote control device in fact may have a multitude of user input devices, such as in a standard multimedia remote control. In fact, numerous other types of input selection devices may be utilized as the user input device 111 and should in fact be understood to be within the scope of the present invention.

FIG. 2A shows an illustrative front view of the remote control device 110 showing the frontal exposure of the receiving device 112, such as an infrared receiving device, and the sending device 114, such as an infrared sending device. FIG. 2B shows an illustrative side view of the remote control device 110 showing relative positioning of the receiving device 112 and the sending device 114. As shown, the sending device is positioned towards an outside portion of the remote control device 110, for example towards a front portion of the remote control device 110. The receiving device 112 however is positioned within a portion of the remote control device 110, illustratively shown as an internal tunnel 116 of the remote control device 110.

What should be clear by this relative positioning of the receiving device 112 and the sending device 114, is that the sending device 114 has an ability to send a signal, such as a wakeup signal, over a relatively broad directional path since the angle of transmission is relatively unobstructed by a side of remote control device 110. However, the receiving device 112 only has an ability to receive a signal over a relatively narrow directional path, in this illustrative embodiment, due to the obstructive path of the tunnel 116. For example, in one embodiment the sending device 114 may be substantially omnidirectional while the receiving device 112 may be substantially unidirectional, although lesser degrees of inclusion of transmitted signals and exclusion of received signals are clearly within the scope of the present invention.

For example, if the receiving device 112 where an infrared receiving device, the relative positioning of the receiving device 112 within the tunnel 116 would deter it from receiving an infrared transmission that emanated from a source located towards a side portion of the remote control device 110. In this exemplary embodiment where the receiving device 112 is an infrared receiving device, sidewalls 118 of the tunnel 116 may even be coated with an infrared absorbing coating, such as a black colored coating. The infrared absorbing coating would help further deter receipt of an infrared transmission from other than a position directly in front of the opening of the tunnel 116.

A similar result may be achieved by utilizing a lens assembly, for example, that is constructed to focus directly received (e.g., directly in front of the receiving device 112) infrared transmissions onto the receiving device 112 while dispersing indirectly received infrared transmissions away from the receiving device 112. In accordance with the present invention, what is achieved is a receiving device 112 that may be directionally controlled to receive or not receive transmissions depending on whether a receiving path of the receiving device 112 is pointing in the direction in which the transmission emanates from. While the invention should not be considered to be restricted necessarily to any type of transmitted or received signals, in accordance with the present invention the receiving device 112 receives signals over a relatively narrower directional path than the sending device 114. In this way the remote control device may potentially transmit signals to a plurality of controllable devices that are positionally displaced from each other while receiving signals from only one of the plurality of controllable device. Similarly, the particular means of narrowing the receiving path of the receiving device 112 should not necessarily be considered a limitation on the current invention or the proceeding claims unless specifically recited therein.

In an embodiment in accordance with the present invention, the type of transmitted signals from the sending device 114 may differ from the type of signals received by the receiving device 112. For example, the sending device 114 may send radio frequency signals while the receiving device receives infrared signals. These and other combination of embodiments are intended to be within the scope of the present invention.

Operation of the present invention will be further described with reference to an illustrative embodiment utilizing infrared transmitting and receiving devices on each of the remote control device and the controllable devices. Reference to FIG. 7 and FIGS. 3, 4, and 5 will facilitate further illustrative description of the present invention. FIG. 7 shows a flow diagram 700 illustrating operation of a system in accordance with an embodiment of the present invention. FIGS. 3, 4, and 5 show illustrative embodiments of a system including side views of the remote control device 110 and controllable devices 120, 130, 140 in accordance with an embodiment of the present invention.

In act 710 and as shown in FIG. 3, the remote control device is directed along a directional path 330 at a controllable device 130 that a user desires to control. The user initiates a user input (as shown in FIG. 1) on the remote control device 110 to activate a wakeup signal that is transmitted from the infrared sending device 114 over a broad directional path (e.g., directional paths 320, 330, 340) towards each of the respective controllable devices 120, 130, 140.

In act 720, the wakeup signal is received by each of receiving devices 122, 132, 142 of each of respective controllable devices 120, 130, 140 within a given area (e.g., within a room in which the remote control device is located). In response to the wakeup signal, each of controllable devices 120, 130, 140 transmits corresponding identifying signals via transmitting devices 124, 134, 144 as shown in FIG. 4. Each of the corresponding identifying signals contains identifying information that is sufficient to identify a controllable device from another controllable device. As an example, the identifying information transmitted from controllable device 130 is sufficient to identify controllable device 130 from controllable devices 120, 140.

The identifying signal from controllable device 120 is sent at least along a path 420 towards the remote control device 110. The identifying signal from controllable device 130 is sent at least along a path 430 towards the remote control device 110. The identifying signal from controllable device 140 is sent at least along a path 440 towards the remote control device 110.

As shown however, paths 420, 440 are indirect paths in that they are not aligned in the direction that the remote control device 110 is pointing. Accordingly, the receiving device 112 of the remote control device 110 does not receive the identifying signals from controllable devices 120, 140 that travel along respective paths 420, 440. In the embodiment shown, an absorbing material on an exposed surface 118 of the tunnel 116 may absorb the identifying signals that are illustratively described as infrared signals. However, path 430 is a direct path in that it is aligned in the direction that the remote control 110 is pointing. Accordingly, the receiving device 112 of the remote control device 110 may receive the identifying signal from the controllable device 130.

In act 740, the identifying signal of controllable device 130 is received and in one embodiment optionally examined by the control portion 113 of the remote control device 110. In this embodiment, the received identifying signal is examined to determine which controllable device corresponds to the received identifying signal. In this way, the control portion 113 may thereinafter cause the transmitting device 114 to transmit control signals that are particular to the identified controllable device 130 as shown during act 750 and in FIG. 5. These signals may be received by each of controllable devices 120, 130, 140 however, since the signals are unique to the controllable device 130, only controllable device 130 is controlled by them.

There are many known ways of making a given control signal unique to a particular controllable device. For example, the type of control signal sent may be unique to a given controllable device. In this embodiment, the control portion 113 may contain information on which control signals are suitable for each of a plurality of controllable devices. Once a particular controllable device is identified, the controls signals sent by the remote control 110 may be signals that are particular to that type of controllable device. For example, if the identifying signal received is from a television, the control signals thereafter from the remote control 110 may be unique control signals for a television.

In another embodiment, the control signal itself may contain at least a portion of the identifying information received from the controllable device. In this embodiment, the control signals sent by the remote control device may be similar for a plurality of devices (e.g., a plurality of lamps) with the exception that the control signal includes some portion of the received identifying information. As would be readily understood, any given system may contain combinations of these systems or others that are known for identifying controllable devices. In any event, once a desired controllable device is identified, thereafter the control signals sent will only control that controllable device until the user initiates a further wakeup/identification sequence for another controllable device. Advantageously, this results in only an identified controllable device being controlled by a control signal. Accordingly, once a controllable device is identified, the remote control can be directed in a random direction and still be able to control the identified controllable device.

In an embodiment, the control signals from the remote control device may require further user input after the identification of a particular controllable device. In this event, first the user initiates a wakeup/identification sequence. Thereafter, the user initiates specific control signals to change a characteristic of the controllable device.

In this or other embodiments, the remote control device may send these or other control signals directly after identification of a controllable device without further user input. In this sequence, the user initiates a wakeup/identification sequence. Once the remote control device identifies a controllable device, a further control signal may be sent to the controllable device without further user input. This type of sequence may be suitable, for example, with a lamp controllable device. In this case, immediately after a particular lamp controllable device is identified, a control signal is sent to the lamp to turn it on or off depending on the desired (or selected) state. In some embodiments, a desired control command or particular desired control commands from the remote control device may be initiated by selection of a particular command by the user that without further input by the user, may result in a wakeup/identification and control signal sequence.

FIG. 6 shows an illustrative alternate embodiment of a system 600 including a side view of the remote control device 110 and controllable devices 620, 630, 640, 650, 660 in accordance with an embodiment of the present invention. Each of controllable devices 620, 630, 640, 650, 660 has respective receiving and sending devices 622, 624; 632, 634; 642, 644; 652, 654; and 662, 664 that operate as described previously with regard to other controllable devices. Each of controllable devices 620, 630, 640, 650, 660 may be separately controlled in accordance with the present invention.

A person of ordinary skill in the art would readily appreciate that there are numerous ways of achieving the above described system and devices. Accordingly, the described embodiments should be understood to not be limited to any one particular alternative.

The embodiments of the invention described above are intended for purposes of illustration only, and should not be construed as limiting the appended claims to any particular embodiment or group of embodiments. Numerous alternative embodiments may be devised by those having ordinary skill in the art without departing from the spirit and scope of the following claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise, for example, the sending devices and receiving devices may be combined into a single transceiving device although the use of the term transceiving device is not necessarily intended to exclude separate sending and receiving devices; and

h) no specific sequence of acts is intended to be required unless specifically indicated.

1. A method of remotely controlling a controllable device, the method comprising the acts of:
broadcasting a wakeup signal to solicit transmission of an identifying signal from a controllable device;
receiving the identifying signal over a narrower directional path than the broadcasted wakeup signal;
broadcasting a control signal to the controllable device, wherein the control signal at least partially is determined from the received identifying signal.

2. The method of claim 1, wherein the control signal contains a portion of the received identifying signal.

3. The method of claim 1, further comprising the act of analyzing the received identifying signal to determine a suitable control signal for the controllable device, wherein the broadcasted control signal is the suitable control signal.

4. The method of claim 1, wherein the broadcasted wakeup signal is broadcast in response to a first user input and the control signal is broadcast in response to a second user input.

5. The method of claim 1, wherein the broadcasted wakeup signal and the control signal is broadcast in response to a single user input.

6. The method of claim 1, further comprising the act of aligning a remote control device in the direction of a particular controllable device prior to broadcasting the wakeup signal so that the received identifying signal is received only from the particular controllable device.

7. The method of claim 1, further comprising the act of broadcasting the wakeup signal to a plurality of controllable devices, wherein each of the plurality of controllable devices is positionally displaced from each other of the plurality of controllable devices, and wherein the narrower path of the received identifying information is sufficiently narrow so that only one of a plurality of identifying signals transmitted by the corresponding plurality of controllable devices is received.

8. A remote control device comprising:
a transceiving device configured to broadcast signals and configured to receive signals over a narrower directional path than the broadcasted signals; and
a user input coupled to the transceiving device, wherein the transceiving device is configured to broadcast a wakeup signal in response to activation of the user input, is configured to receive an identification signal from a controllable device, and is configured to broadcast a control signal at least partially determined from the received identification signal.

9. The remote control device of claim 8, wherein the transceiver is configured to be aligned in the direction of one of a plurality of controllable devices that are each positionally displaced from each other of the plurality of controllable devices, and wherein the narrower directional path of the received identifying information is sufficiently narrow so that only the identifying signal of the one of the plurality of controllable devices is received.

10. The remote control device of claim 8, wherein the transceiver is configured to send and receive signals within the infrared spectrum.
